(19) United States
(12) Patent Application Publication
(10) Pub. No.: US 2023/0044995 A1
(43) Pub. Date: Feb. 9, 2023

(54) FIREFIGHTING SYSTEM FOR AN EXTRACTOR DUCT, IN PARTICULAR OF A COOKING ZONE

(71) Applicant: Minimax Viking Research & Development GmbH, Bad Oldesloe (DE)

(72) Inventors: Frank RÖNNFELDT, Bad Oldesloe (DE); Stefan SCHNELL, Bad Oldesloe (DE)

(21) Appl. No.: 17/614,162

(22) PCT Filed: Jun. 3, 2020
(86) PCT No.: PCT/EP2020/065262

§ 371 Date: Oct. 24, 2022

(30) Foreign Application Priority Data
Jun. 3, 2019 (DE) 10 2019 114 873.1

(51) Int. Cl. A62C 3/00; A62C 31/00

(52) U.S. Cl. CPC A62C 3/006; A62C 31/005

(57) ABSTRACT

The invention presents a firefighting system for an extractor duct, in particular of a cooking area, having a duct, which has an inlet side and an outlet side, which is spaced apart from the inlet side, and defines a direction of the extracted air flow from the inlet side to the outlet side. The invention also proposes that at least one spray mist nozzle, preferably a plurality of spray mist nozzles, are installed in the firefighting system, said spray mist nozzles each having a plurality of separate spray mist outlets, wherein the spray mist outlets each have a predetermined K-factor and are oriented at an angle to one another.

### PRIORITY CLAIM AND INCORPORATION BY REFERENCE

This application is a 35 U.S.C. § 371 application of International Application No. PCT/EP2020/065262, filed Jun. 3, 2020, which claims the benefit of German Application No. 10 2019 114 873.1, filed Jun. 3, 2019, each of which is incorporated by reference in its entirety.

### BACKGROUND OF THE INVENTION

Firefighting systems are used in many places to monitor rooms and objects, in order, if a fire breaks out, for it to be possible to discharge extinguishing agent quickly and in a targeted manner so as to contain and at best extinguish the fire. A particular application of such firefighting systems is firefighting by discharging extinguishing agent in extractor ducts. These can be, for example, extractor ducts of air-conditioning systems, ventilation systems or extractor ducts for carrying away cooking fumes, also known as vapors. Cooking fumes are frequently made up of a mixture of ambient air, steam and carbon-containing solids, and fats, carried along by steam.

In the case of extractor ducts that carry only air, firefighting is always advisable when the spread of fire through a building is intended to be contained; the fire frequently finds its way through the building via conduit systems. In the case of relatively large duct cross sections, it is no longer possible to ensure that such ducts are closed by means of conventional fire protection devices, which are based for instance on the swelling of intumescent material, for example expandable graphite, and are intended to prevent the spread of fire by closing the conduit cross section. Although the swelling capacity of the known materials is high, it has limits for structural reasons.

Starting from particular cross-sectional diameters in the ducts, the use of discharging devices for extinguishing fluid is thus advisable, for example in the form of spray mist nozzles.

In extractor ducts that carry combustible materials, for example fats, fire can additionally break out in the duct itself, when deposited fats are ignited.

The design of firefighting systems for extractor ducts that have a duct which comprises an inlet side and an outlet side, which is spaced apart from the inlet side, and defines a direction of the extracted air flow from the inlet side to the outlet side, is complex. Thus, it is necessary, within the duct, not only to reliably supply the entire duct cross section, transversely to the extraction direction, evenly with extinguishing fluid, but also to distribute as much distinguishing fluid as possible in the extraction direction, in order for it to be possible to combat any fires that already exist there. It is necessary here to carefully plan the spacing of possibly several extinguishing agent discharging devices from one another. Furthermore, the extinguishing agent itself is a limited resource in many applications, for example notably on ships, since, for extinguishing purposes, it is not always possible to use seawater, which, on account of its salt content, would severely corrode the conduits of a conduit system of a firefighting system, thereby impairing its service life. Moreover, the operating pressure with which the extinguishing agent can be provided to the extinguishing agent discharging devices is mainly responsible for the installation complexity of the firefighting system. A higher operating pressure requires greater stability of the installed components and higher energy costs with regard to the power supply, the water supply and the generators, in particular on ships.

Against this background, the need arose for an improvement in the known firefighting systems in general, but in particular for extractor ducts that are assigned to cooking areas.

### SUMMARY OF THE INVENTION

Therefore, the invention was based on the object of improving a firefighting system of the type set out at the beginning such that the abovementioned drawbacks are overcome as far as possible. In particular, the invention was based on the object of specifying a firefighting system for an extractor duct of a cooking area, which overcomes the drawbacks indicated above as far as possible.

The invention achieves the object on which it is based in that at least one spray mist nozzle, preferably a plurality of spray mist nozzles, are installed in the firefighting system, said spray mist nozzles each having a plurality of separate spray mist outlets, wherein the spray mist outlets each have a predetermined K-factor and are oriented at an angle to one another.

The K-factor is defined, in the context of the invention, as being a characteristic number determined using the following equation:

K=Q/√p

where Q is the volumetric flow rate in l/min, and p is the static pressure upstream of the nozzle in bar.

The invention is based on the approach that, as a result of the use of spray mist nozzles each having a plurality of spray nozzle outlets, a much more extensive spread of the extinguishing agent within the duct can be achieved than with nozzles that have only one spray mist outlet. In addition, the spacing of the spray mist nozzles can be chosen to be as large as possible, this entailing reduced installation complexity of the firefighting system. In addition, the spray mist outlets allow the spray characteristics to be adapted to the particular structural conditions.

In a first aspect, the invention is advantageously developed in that the firefighting system has a hood, arranged on the inlet side of the extractor duct and in particular assigned to the cooking area, for receiving cooking fumes from the cooking area, wherein the inlet side of the duct is fluidically connected to the hood, and wherein a spray mist nozzle is installed in the hood, said spray mist nozzle having a plurality of separate spray mist outlets which each have a predetermined K-factor and are oriented at an angle to one another. In the context of the invention, the term “hood” is understood as meaning in general that component that receives the mixture of substances to be conveyed away by the extractor duct, for example ambient air or in particular cooking fumes. Such a hood can be open to the side and/or downwardly. It can be attached to the ceiling of a room, hang down from the ceiling or be arranged on a side wall of a room. In the context of the invention, a hood is also understood as being those receiving openings for the mixture of substances to be conveyed away that are not located vertically above the point at which the mixture of substances to be conveyed away arises but at the same level or lower down, and that initially convey the mixture of substances downward before it enters the extractor duct.

The hood preferably has two opposite side walls, and the hood spray mist nozzle is installed on one of the side walls and is designed to emit spray mist in the direction of the opposite side wall. In a further preferred embodiment, the spray mist outlets of the hood spray mist nozzle are oriented in a plane, preferably horizontally. This relates in particular to those configurations in which the inlet opening of the hood is directed upward or downward, i.e. is arranged for example above or below a cooking area. Preferably, the plane in which the spray mist outlets of the hood spray mist nozzle are arranged is parallel to the inlet opening of the hood.

In a further preferred embodiment, the hood spray mist nozzle has a first spray mist outlet, which is oriented perpendicularly to the opposite side wall, and two second spray mist outlets, which are each oriented at a predetermined angle to the first spray mist outlet. As a result, the cross section of the duct is intended to be crossed in a targeted manner by the first spray mist nozzle, while the two second spray mist outlets can be aligned with third and fourth side walls of the hood, in order for it to be possible to cover the entire opening area of the hood with spray mist, and in particular also the corresponding side walls.

In a particularly preferred embodiment, the K-factor of the first spray mist outlet is higher than the K-factors of the second spray mist outlets. This entails a particular advantage that the inventors have identified. As a result of the higher K-factor of the first spray mist outlet, the first spray mist outlet has a greater casting distance than the second spray mist outlets. Instead, the second spray mist outlets have a finer atomizing characteristic. Since the spray mist outlets are oriented at a predetermined angle to one another, the following effect arises according to the invention: The fine spray mist of the second spray mist outlets is partially carried along by the spray mist from the first spray mist outlet, and so, on account of the K-factor differentiation according to the invention, finer spray mist is also driven further in the direction of the second side wall than would be the case if all the spray mist outlets had the same K-factor. As a result, a greater firefighting effect is achieved with the same water requirement.

In a preferred configuration, the K-factor of the first spray mist outlet of the hood spray mist nozzle lies in a range from 0.6 to 0.9.

More preferably, the K-factor of the first spray mist outlet is three to four times as high as the K-factor of the second spray mist outlets of the hood spray mist nozzle, wherein preferably the K-factor of the second spray mist outlets of the hood spray mist nozzle lies in a range from 0.15 to 0.25.

The invention was described above on the basis of a first aspect. In a second aspect, which is both a preferred embodiment of the first aspect and, at the same time, an independent aspect, the invention proposes, in a firefighting system of the type set out at the beginning, that one or more duct spray mist nozzles are installed in the duct, in particular downstream of the hood, wherein each duct spray mist nozzle has a plurality of separate spray mist outlets, which each have a predetermined K-factor and are oriented at an angle to one another.

The preferred embodiments and advantages, described below, of the firefighting system according to the second aspect are at the same time preferred embodiments and advantages of the firefighting system according to the first aspect, and the advantages and preferred embodiments of the firefighting system according to the first aspect are also preferred embodiments and advantages for the second aspect.

Preferably, the duct of the firefighting system has two opposite side walls, and the duct spray mist nozzle is installed on one of the side walls and is designed to emit spray mist in the direction of the opposite side wall. The spray mist nozzle in the duct is preferably installed in a vertical side wall.

The spray mist outlets of the duct spray mist nozzle are preferably oriented in a plane, preferably parallel to the direction of the duct. In the case of a horizontal duct, the spray mist outlets are thus oriented in a horizontal plane. If, however, the duct is inclined slightly relative to the horizontal, this frequently being the case in practice, the spray mist outlets are preferably oriented in a likewise slightly inclined plane.

In a preferred embodiment, the spray mist nozzles are oriented as follows: Preferably, the duct has a mounting opening in that side wall into which the spray mist nozzle is intended to be installed, and the spray mist nozzle is mounted in the side wall from the outside through the mounting opening, wherein the duct has a first positioning element on an outer side of the side wall and wherein the duct spray mist nozzle has a corresponding second positioning element, wherein the first positioning element is positioned in such a way relative to the mounting opening that the two positioning elements, when they are aligned with one another, bring about a correct orientation of the plane of the spray mist outlets relative to the direction of the duct. The positioning elements can be, for example, optical indicators that are oriented in an aligned manner with one another or so as to face one another, or engage in one another in a form-fitting manner. In the latter case, the spray mist nozzle can preferably only be mounted on the duct when the positioning elements are aligned correctly with one another. As a result of the provision of the positioning elements, the risk of misalignment of the spray mist nozzle is reduced. Visual inspection of the duct interior becomes superfluous, and the installation complexity and the installation quality are optimized considerably as a result.

In a further preferred embodiment, the duct spray mist nozzle has a first spray mist outlet, which is oriented perpendicularly to the opposite side wall, and two second spray mist outlets, which are each oriented at a predetermined angle to the first spray mist outlet, wherein one of the second spray mist outlets is directed counter to the direction of the extracted air flow and the other of the second spray mist outlets is directed in the direction of the extracted air flow. The direction of the extracted air flow is in this case more or less the direction of the duct. The orienting of one of the second spray mist outlets in an upstream direction in the duct and of the other of the second spray mist outlets in a downstream direction of the duct results in particularly good spray mist distribution with regard to the duct direction, while the first spray mist outlet supports a distribution of the spray mist transversely to the direction of the extracted air flow in a targeted manner.

Preferably, the K-factors of the first and second spray mist outlets of the duct spray mist nozzle are each identical, and preferably lie in a range from 0.2 to 0.5.

Alternatively, it is preferred that the K-factor of the first spray mist outlet of the duct spray mist nozzle is higher than the K-factors of the second spray mist outlets of the duct spray mist nozzle, and that the sum of the K-factors of the first and second spray mist outlets lies in a range from 0.9 to 1.5.

The advantage of a first spray mist outlet with a higher K-factor is, as described above in relation to the first aspect, a greater casting distance of the spray mist from the first spray mist outlet, which entrains more finely atomized extinguishing agent from the second spray mist outlets in the transverse direction to the duct.

In a third aspect, the invention relates to particularly preferred parameterization of the firefighting system. The advantages and preferred embodiments of the first and second aspects are at the same time advantages and preferred embodiments of the third aspect, and so, to avoid repetition, reference is made to what was said above. The following preferred embodiments of the third aspect are at the same time preferred embodiments of the first and second aspects.

Preferably, the hood has an inlet cross-sectional area in a range from 3 m² to 5 m² and a maximum spacing of horizontally opposite side walls in a range from 2 m to 4 m.

More preferably, the duct has a flow area in a range from 1 m² to 2 m² and a maximum spacing of horizontally opposite side walls in a range from 1 m to 2 m.

More preferably, the hood spray mist nozzle and a duct spray mist nozzle installed adjacent thereto have a spacing in a range from 1 m to 3 m in the direction of the extracted air flow.

More preferably, a plurality of duct spray mist nozzles are installed in the duct and have a spacing in a range from 9 m to 11 m from one another in the direction of the extracted air flow.

In a further preferred embodiment, the spray mist nozzles are fluidically connected to an extinguishing fluid supply, wherein the spray mist nozzles and the extinguishing fluid supply are designed for an operating pressure at the spray mist nozzles in a range of 70 bar or less, preferably in a range from 50 bar to 65 bar.

More preferably, the duct has an elbow, wherein a duct spray mist nozzle is installed downstream and/or upstream of the elbow and has a spacing in a range of 6 m or less from the elbow. An elbow is understood here as meaning a component that brings about a change in direction of the duct, for example about a vertical axis or a horizontal axis, preferably through 45° or more, particularly preferably through 90° or more.

In a particularly preferred embodiment, the above parameters of the third aspect are realized simultaneously, achieving superior efficiency in the use of the extinguishing agent compared with previous systems, while having low installation complexity and yet an unreduced high firefighting capacity.

In further preferred embodiments, the spray mist nozzle or spray mist nozzles is or are formed partially or entirely from stainless steel. The use of stainless steel as nozzle material considerably increases the range of temperatures that can be used compared with copper nozzles and copper components known from the prior art. As a result, a very much higher temperature reserve is provided.

In a further preferred embodiment, the spray mist nozzles are in the form of open extinguishing nozzles.

In a further preferred embodiment, one or more fire characteristic sensors are installed at the hood and/or at the duct, wherein the firefighting system has a triggering device that is connected to the fire characteristic sensors indirectly or directly in a signal-conducting manner and is designed to start the feed of extinguishing agent to the spray mist nozzles as soon as the fire characteristic sensors sense the reaching or exceeding of a predetermined fire characteristic threshold or the existence of a fire characteristic. According to the invention, fire characteristics are for example temperatures, smoke aerosols, electromagnetic radiation of flames, sparks or pockets of embers or fire gases.

### BRIEF DESCRIPTION OF THE DRAWINGS

The invention is described in more detail in the following text on the basis of a preferred exemplary embodiment with reference to the accompanying figures, in which:

FIG. 1 shows a schematic three-dimensional view of a firefighting system according to a preferred exemplary embodiment,

FIGS. 2a to c show schematic detail views of the firefighting system according to FIG. 1,

FIGS. 3a to g show further schematic detail views of the firefighting system according to FIGS. 1 to 2c,

FIGS. 4a-4c show different schematic illustrations of a spray mist nozzle according to a preferred exemplary embodiment,

FIG. 5 shows a schematic cross-sectional view through a nozzle insert for the spray mist nozzle according to FIGS. 4a-4c,

FIGS. 6a-6c show different schematic illustrations of a main body of the nozzle insert according to FIG. 5, and

FIGS. 7a-7e show different schematic illustrations of a swirl body for the nozzle insert according to FIGS. 4a-6c.

### DETAILED DESCRIPTION OF THE INVENTION

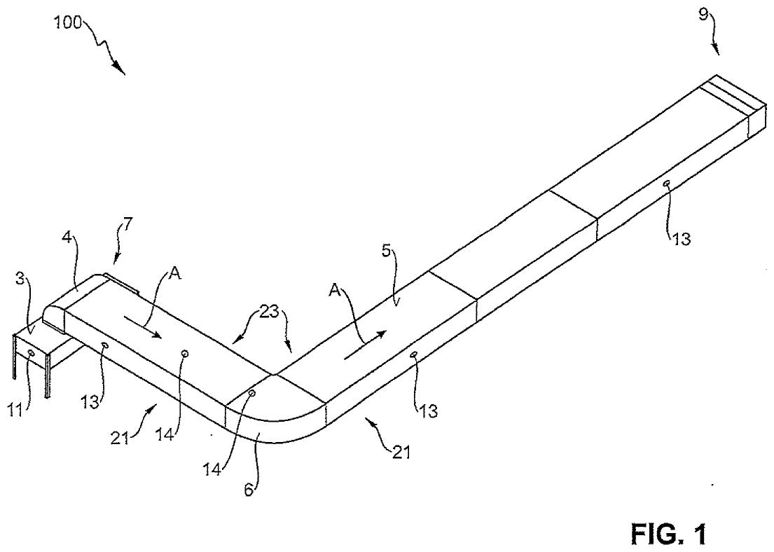

FIG. 1 shows a firefighting system 100. The firefighting system 100 has a hood 3, which is designed to receive mixtures of substances to be conveyed away, for example for receiving cooking fumes from a cooking area located beneath the hood.

Attached to the hood 3 is an elbow 4, which deflects the entering flow of a mixture of substances through about 90° about a horizontal axis and then transfers it into a duct 5, also known as an extractor duct. The duct 5 extends from its hood-side inlet side 7 as far as an outlet side 9, at which optionally one or more flow generators for forced extraction can be arranged.

The duct 5 defines a direction of flow A of the extracted air, which is substantially identical to the orientation of the duct 5. The hood 3 has a hood spray mist nozzle 11. At least one duct spray mist nozzle 13 is arranged in the duct 5 in a manner spaced apart from the hood spray mist nozzle 11. In the present exemplary embodiment, there are three duct spray mist nozzles 13.

The duct 5 has an elbow 6, in which the course of the duct 5 is deflected through 90° about a vertical axis. From a first duct spray mist nozzle 13 to the elbow 6, there is a spacing in a range from 4 m to 6 m. On the downstream side of the elbow 6 there is a second duct spray mist nozzle 13, which is arranged at a distance in a range from 4 m to 6 m from the elbow.

Arranged further downstream is a third duct spray mist nozzle, which is arranged at a spacing in a range from 9 m to 12 m from the second duct spray mist nozzle 13.

The duct spray mist nozzles 13 are mounted preferably in a first side wall 21 of the duct 5 and designed to emit a spray mist in the direction of the opposite second side wall 23 of the duct 5. Details about the orientation of the spray mist nozzles can be gathered from the following figures.

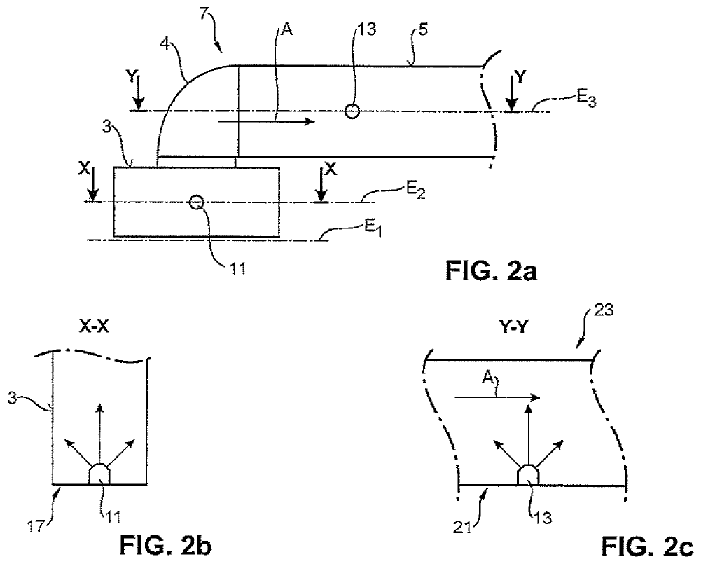

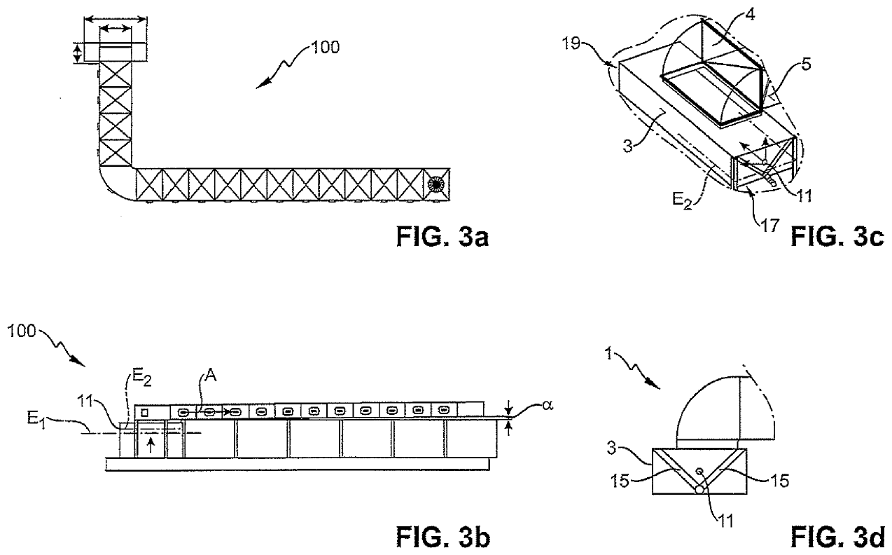

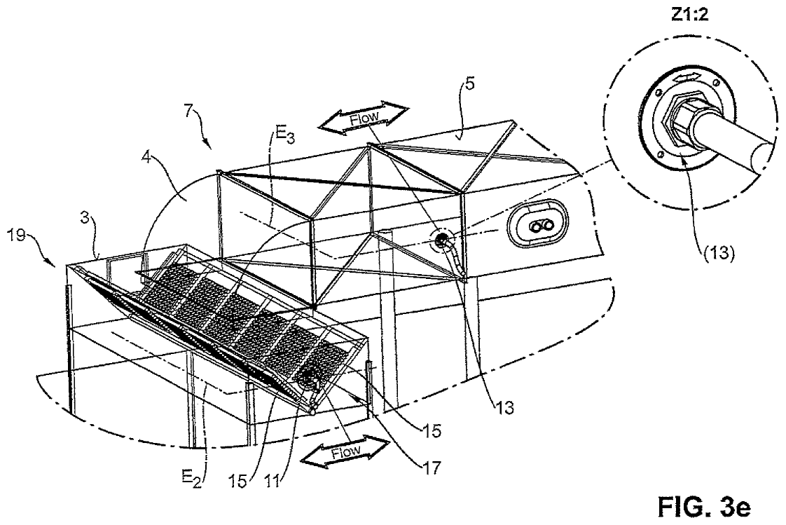

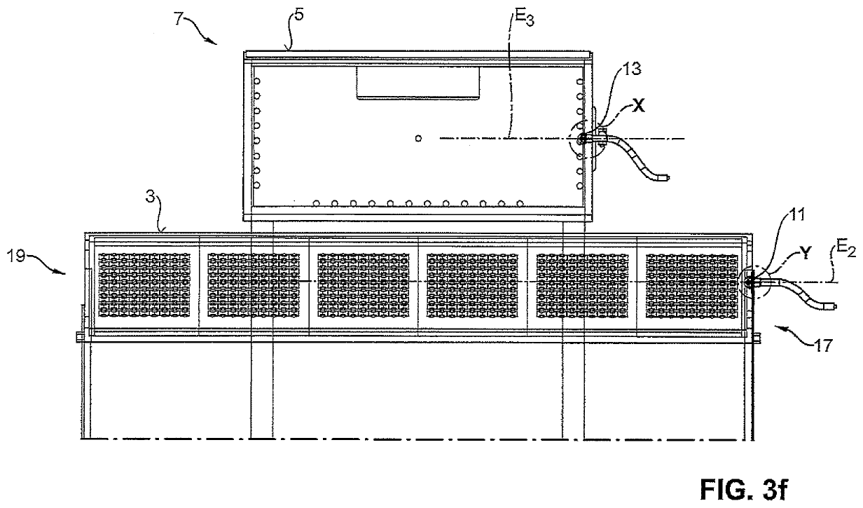

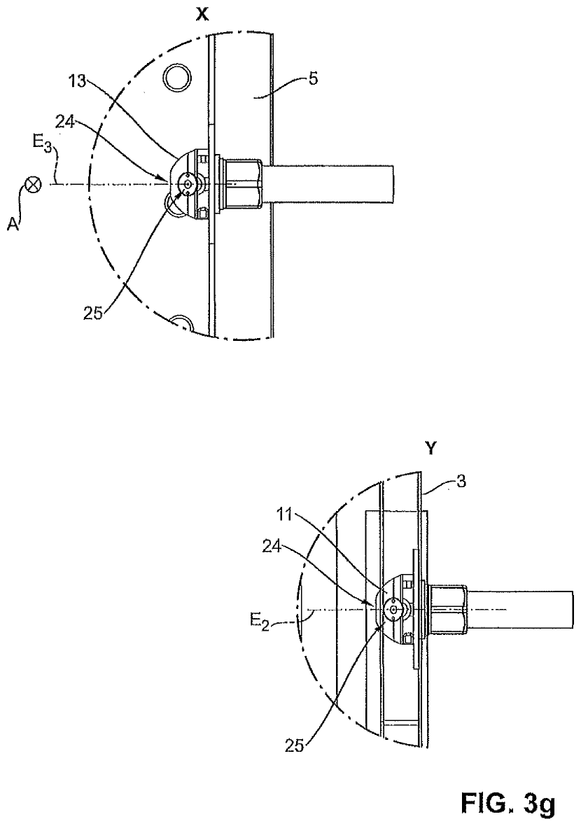

As is apparent from viewing FIGS. 2a to c in combination, the hood spray mist nozzle 11 has a plurality of spray mist outlets, which lie in a common plane E₂. The plane E₂ is parallel to a plane E₁ that defines the inlet cross section to the hood 3. The hood spray mist nozzle 11 is positioned in a first side wall 17 of the hood 3 and designed to emit spray mist through the spray mist outlets in the direction of the opposite side wall 19, cf. FIG. 3a.

Within the duct 5, the duct spray mist nozzles 13, one of which is depicted in FIGS. 2a and c, are arranged such that the spray mist outlets are each arranged in a common plane E₃ parallel to the direction of flow A of the extracted air and thus to the direction of the duct 5. In the case of a horizontal duct 5, the plane E₃ in which the spray mist outlets of the duct spray mist nozzle 13 lie would likewise be horizontal.

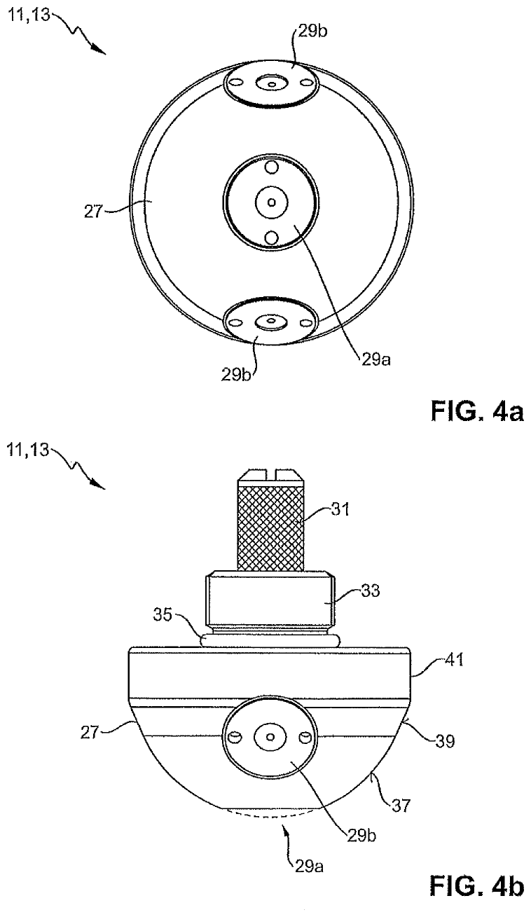

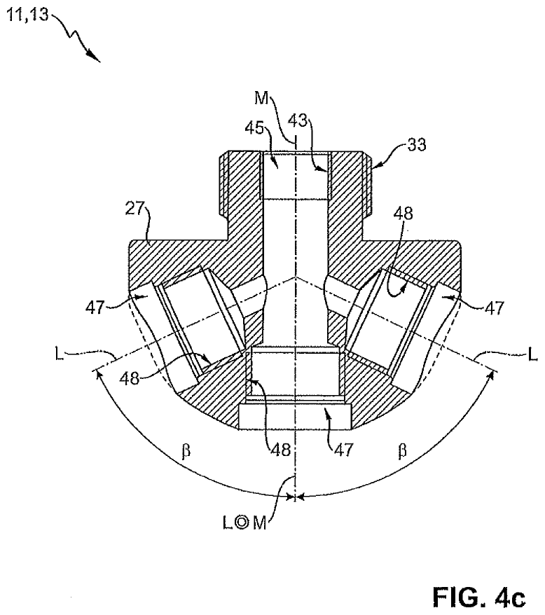

Of the spray mist outlets of the duct spray mist nozzle 13, a first spray mist outlet is oriented transversely to the direction of flow A of the extracted air, while a second spray mist outlet is arranged counter to the direction of flow, and a further second spray mist outlet is arranged at an angle relative to the first spray mist outlet in the direction of flow. This is explained in more detail in FIG. 4a et seq. for the hood spray mist nozzle 11 and the duct spray mist nozzles 13.

In FIG. 3a, which shows a plan view of the firefighting system according to FIG. 1, the dimensions of the hood 3 relative to the duct 5 are apparent. The hood 3 has a cross-sectional area B₁-B₂ of about 3 m² to 5 m².

Starting from the hood 3, it merges into the duct 5 of smaller cross-sectional area, which has a width B₃ and a height H₁, preferably in the range from 1 m² to 2 m².

As indicated schematically in FIG. 3b, the duct 5 is inclined at least partially at an angle α relative to the horizontal, such that the direction of flow A of the extracted air does not extend exactly horizontally. The orientation of the spray mist nozzles preferably takes this into account.

FIGS. 3c to 3g illustrate the orientation of the hood spray mist nozzle 11 with the spray mist outlets in the plane E₂, substantially in the direction of the opposite second side wall 19. In the hood, a V-shaped separator is arranged preferably in the direction of the inlet cross section in the plane E₁, as seen from the hood spray mist nozzle 11.

While FIGS. 1 to 3g have shown in general the structure of the firefighting system and the positioning of the spray mist nozzles 11, 13, the following figures show an example of a preferred structure of the spray mist nozzles 11, 13 themselves.

FIG. 4a shows, by way of example, a spray mist nozzle which can be used as a hood spray mist nozzle 11 or as a duct spray mist nozzle 13. The spray mist nozzle 11, 13 has a housing 27 into which a first nozzle insert 29a and two second nozzle inserts 29b have been inserted.

In FIG. 4b, the spray mist nozzle 11, 13 is illustrated in a side view. On the inlet side, the spray mist nozzle 11, 13 has a screening body 31. The housing 27 has a thread 33 for installing the spray mist nozzle. A sealing ring 35 is provided for sealing the housing 27 off from the installation body. The housing has a convexly curved, preferably partially spherical surface portion 37, which is adjoined by a frustoconical surface portion 39. Toward the inlet side, the housing 27 has a cylindrical surface portion 41. The nozzle inserts end substantially flush with the surface of the housing 27.

FIG. 4c depicts a cross-sectional view through the housing 27 of the spray mist nozzle 11, 13. The housing 27 has an extinguishing fluid inlet 45. Provided on the inner side of the extinguishing fluid inlet 45 is an internal thread 43 for mounting the screening body 31 (cf. FIG. 1).

The housing has a plurality of recesses 47 each for receiving a nozzle insert 29a, b. The recesses 47 each have an internal thread for screwing in the nozzle inserts 29a, b. Furthermore, the nozzle inserts 29a, b are fluidically connected to the extinguishing fluid inlet 45.

One of the recesses 47 is oriented coaxially with a mounting direction M defined by the extinguishing fluid insert 45, such that the longitudinal axis L of the nozzle insert 29a to be inserted into the recess 47 is likewise oriented coaxially with the mounting direction. The remaining recesses 47 are oriented at an angle β to the mounting direction M. The angle β is preferably in a range between 50° and 70°, particularly preferably 60° or 65°.

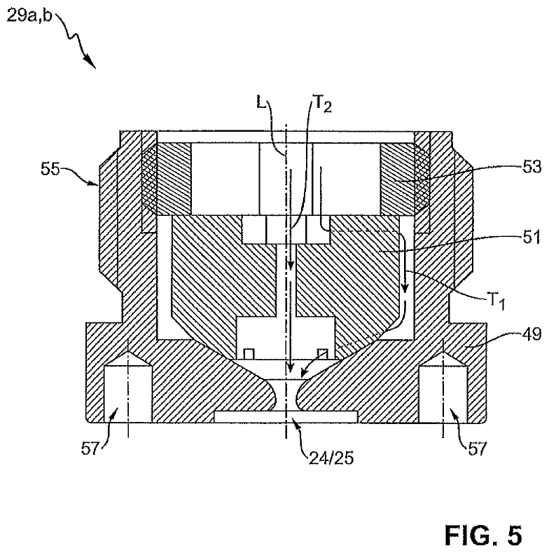

While FIGS. 4a-4c focused on the housing, FIG. 5 now shows the nozzle insert 29a, b that is intended to be inserted into the recesses 47. The nozzle insert 29a, b has a main body 49. Inserted in the main body 49 is a swirl body 51, which is oriented coaxially with the longitudinal axis L. The swirl body 51 is fixed in the main body 49 by means of a screwed-in retaining ring 53.

The main body 49 has an external thread 55 for screwing it into the respective recess 47. In order to make it easier to screw in the nozzle insert 29a, b, recesses 57 for attaching a screwdriving tool are provided on each outlet-side end face of the nozzle insert 29a, b.

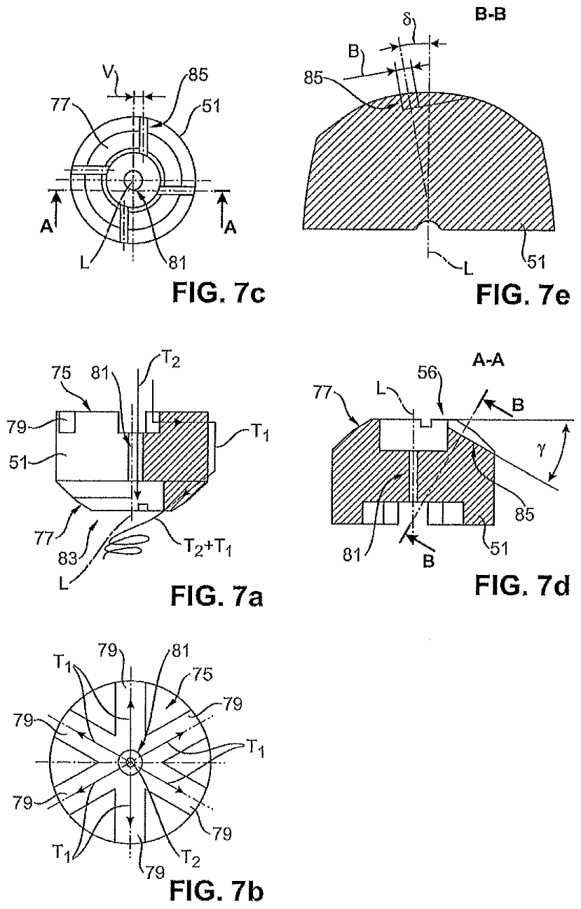

The main body 49 has a spray mist outlet 24/25 through which the extinguishing fluid entering through the extinguishing fluid inlet 23 leaves the spray mist nozzle 1 in the form of spray mist after flowing through the nozzle insert 29a, b. The spray mist is generated in that a first part T₁ of the entering extinguishing fluid is deflected outward in the direction of the arrows T₁ by the swirl body 51 into the peripheral region thereof and into the vicinity of a wall of the main body 49, in order then, on flowing up to the spray mist outlet 24/25, to be made to form a vortex. A second part flow T₂ passes through the swirl body 51, in the middle of the latter, through a passage opening (cf. FIGS. 7a-e).

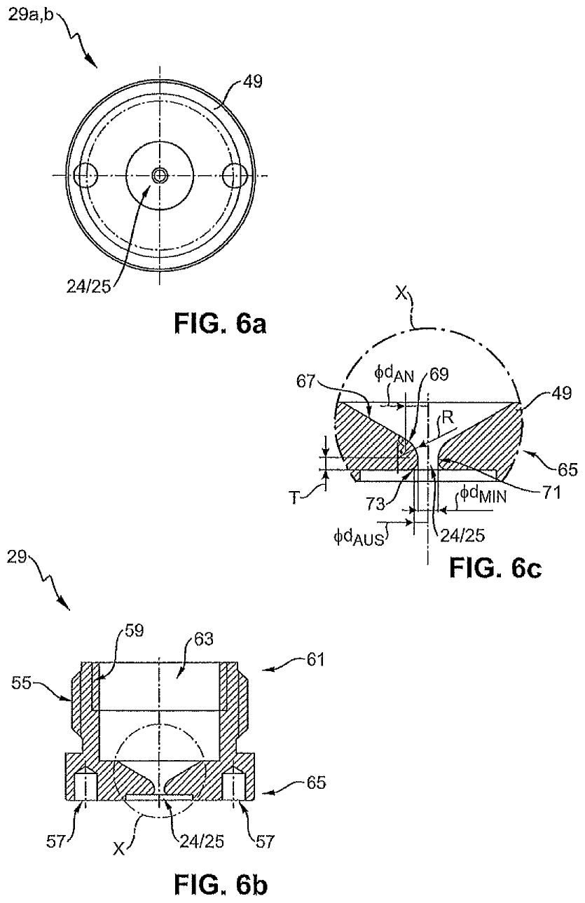

In the following text, with reference to FIGS. 6a-6c, the main body 49 will be discussed further. The main body 49 of the nozzle insert 29a, b has an inlet-side end face 61 and an outlet side end face 65. Between these two end faces 61, 65 there extends a passage opening 63 in which the swirl body 51 is received (cf. FIG. 2) and which leads into the spray mist outlet 24/25. The spray mist outlet 24/25 is depicted in detail in FIG. 6c.

Upstream of the spray mist outlet 24/25, the main body 49 has a seat 67 on which the swirl body 51 is supported. The seat 67 transitions at a point into the spray mist outlet 24/25. The cross section at which the seat 67 transitions into the cross section of the spray mist outlet 24/25 is what is known as the incident-flow area 69. In the incident-flow area 69, the spray mist outlet 24/25 has a diameter dₐₙ. The transition from the seat 67 to the spray mist outlet 24/25 preferably takes place smoothly.

At its narrowest point, the spray mist outlet 24/25 has a minimum flow area 71. The minimum flow area 71 is offset inwardly at a depth T from the outlet-side end face 65.

Downstream of the minimum flow area 71, the spray mist outlet 24/25 widens along a convexly extending curve and has, at an outlet cross section 73, a diameter dₐᵤₛ, which is greater than the diameter at the minimum flow area 71. The diameter at the minimum flow area 71 is denoted dₘᵢₙ.

Preferably, the transition from the incident-flow area 69 to the minimum flow area 71 takes place along a convexly curved surface with a radius of curvature R. More preferably, the transition from the minimum flow area 71 to the outlet cross-sectional area 73 likewise takes place along a convexly curved surface, in the present exemplary embodiment likewise with the radius of curvature R. Particularly, preferably, the convexly curved surface from the incident-flow area 69 to the outlet cross-sectional area 69 is formed smoothly, i.e. without a kink. Particularly preferably, the course of the curve is formed in an uninterrupted and constant manner with the same radius of curvature R. The contour, rounded by the convex curvature, of the spray mist outlet 24/25 generates unexpectedly clear stabilization of the K-factor of the nozzle insert 29a, b.

In FIGS. 7a-7e, the swirl body 51 for the nozzle insert 29a, b of the present exemplary embodiment is described in more detail in the following text. First of all, FIG. 7a shows a side view of the swirl body 51 with a partially exposed cross section. Extinguishing fluid flows up to the swirl body 51 on a first, inlet-side end face 75. A first part T₁ is redirected by a plurality of radially extending grooves 79 to the outer circumference of the swirl body 51. This is also shown in FIG. 7b. A second part T₂ flows, without being redirected to the outer circumference, through a passage opening 81 to a second end face 83 of the swirl body 51. The first part flow T₁, as is readily apparent in particular in FIG. 7c, is conveyed by a plurality of vortex ducts 85 that are arranged eccentrically and in a radial-parallel manner relative to the longitudinal axis L back in the direction of the spray mist outlet 24/25, wherein, as a result of the off-center arrangement of the vortex ducts 85, a vortex flow is generated in the volume between the swirl body 51 and the main body 49 upstream of the spray mist outlet. In this free space, the two part flows T₁ and T₂ are reunited and driven jointly through the spray mist outlet 24/25.

The vortex ducts 85 are preferably all offset by the same offset V with respect to a respective radial.

As is readily apparent from FIG. 7d, the vortex ducts 85 are inclined at an angle γ relative to the outlet-side second end face 83 of the swirl body 51. Preferably, the vortex ducts 85, or the groove bottoms of the vortex ducts 85, are oriented parallel to a seat 77 of the swirl body 51.

In addition, as shown in FIG. 7e, the vortex ducts 85 are provided with a width B in the swirl body 51 and are additionally pivoted through an angle δ with respect to the longitudinal axis L.

In the above figures, on the basis of the above exemplary embodiment, a high-pressure spray mist nozzle 1 having a total of three nozzle inserts 29a, b has been shown. Also encompassed by the invention are spray mist nozzles which have a different number of nozzle inserts, for example five, seven or more nozzle inserts, and in which either in each case one nozzle insert is oriented coaxially with the mounting direction M or in which all of the nozzle inserts are oriented at an angle β to the mounting direction M, or in which one or more recesses 47 are not provided with a nozzle insert 29a, b or are closed by a blind plug or similar closure element.

### LIST OF REFERENCE NUMBERS AND SYMBOLS

100 Firefighting system

3 Hood

4 Elbow

5 Duct

6 Elbow

7 Inlet side

9 Outlet side

11 Hood spray mist nozzle

13 Duct spray mist nozzle

14 Temperature sensor

15 Separator

17 Side wall, hood

19 Side wall, hood

21 Side wall, duct

23 Side wall, duct

24 First spray mist outlet

25 Second spray mist outlet

E₁, E₂, E₃ Plane

A Flow direction, extracted air

B Width, vortex duct

dₐₙ Incident-flow area

dₘᵢₙ Minimum flow area

dₐᵤₛ Outlet cross-sectional area

L Longitudinal direction

M Mounting direction, spray mist nozzle

T₁, T₂ Part flow, extinguishing fluid

T Depth, minimum flow area

V Offset, vortex duct

α Pitch angle, duct

β Angle, spray mist outlet

γ Angle, vortex duct

δ Angle, vortex duct

27 Housing

29a,b Nozzle insert

31 Screening body

33 Thread

35 Sealing ring

37 Partially spherical surface portion

39 Frustoconical surface portion

41 Cylindrical portion

43 Internal thread

45 Extinguishing fluid inlet

47 Recess for nozzle insert

48 Internal thread, nozzle insert

49 Main body

51 Swirl body

53 Retaining ring

55 External thread

57 Recess

59 Internal thread

61 Inlet-side end face, main body

63 Passage opening

65 Outlet-side end face, main body

67 Seat, main body

69 Incident-flow area

71 Minimum flow area

73 Outlet cross-sectional area

75 First end face, swirl body

77 Seat, swirl body

79 Groove

81 Passage opening, swirl body

83 Second end face, swirl body

85 Vortex duct

1. A firefighting system of a cooking area, comprising:
a duct which has an inlet side and an outlet side, which is spaced apart from the inlet side, and defines a direction of an extracted air flow from the inlet side to the outlet side, and
at least one spray mist nozzle, said at least one spray mist nozzle having a plurality of separate spray mist outlets, wherein the spray mist outlets each have a predetermined K-factor and are oriented at an angle to one another.

2. The firefighting system as claimed in claim 1, further comprising a hood, arranged on the inlet side of the duct and assigned to the cooking area, for receiving cooking fumes from the cooking area, wherein the inlet side of the duct is fluidically connected to the hood,
wherein the at least one spray mist nozzle comprises a hood spray mist nozzle is installed in the hood, said hood spray mist nozzle having the plurality of separate spray mist outlets which each have a predetermined K-factor and are oriented at an angle to one another.

3. The firefighting system as claimed in claim 2, wherein the hood has two opposite side walls, and the hood spray mist nozzle is installed on one of the side walls and is designed to emit spray mist in the direction of the opposite side wall.

4. The firefighting system as claimed in claim 2, wherein the spray mist outlets of the hood spray mist nozzle are oriented in a horizontal plane.

5. The firefighting system as claimed in claim 3, wherein the hood spray mist nozzle has a first spray mist outlet, which is oriented perpendicularly to the opposite side wall, and two second spray mist outlets, which are each oriented at a predetermined angle to the first spray mist outlet.

6. The firefighting system as claimed in claim 5, wherein the K-factor of the first spray mist outlet is higher than the K-factors of the second spray mist outlets.

7. The firefighting system as claimed in claim 6, wherein the K-factor of the first spray mist outlet of the hood spray mist nozzle lies in a range from 0.6 to 0.9.

8. The firefighting system as claimed in claim 6, wherein the K-factor of the first spray mist outlet is three to four times as high as the K-factor of the second spray mist outlets of the hood spray mist nozzle, and wherein the K-factor of the second spray mist outlets of the hood spray mist nozzle lies in a range from 0.15 to 0.25.

9. The firefighting system as claimed in claim 1, wherein the at least one spray mist nozzle comprises one or more duct spray mist nozzles installed in the duct, wherein each duct spray mist nozzle has the plurality of separate spray mist outlets, wherein the spray mist outlets each have a predetermined K-factor and are oriented at an angle to one another.

10. The firefighting system as claimed in claim 9, wherein the duct has two opposite side walls, and the duct spray mist nozzle is installed on one of the side walls and is designed to emit spray mist in the direction of the opposite side wall.

11. The firefighting system as claimed in claim 9, wherein the spray mist outlets of the duct spray mist nozzle are oriented in a plane, parallel to the direction of the duct.

12. The firefighting system as claimed in claim 11, wherein the spray mist nozzle is mounted on the duct from the outside through a mounting opening in the side wall, and the duct has a first positioning element on an outer side of the side wall, on which the duct spray mist nozzle is mounted, and wherein the duct spray mist nozzle has a corresponding second positioning element, wherein the first positioning element is positioned in such a way relative to the mounting opening that the two positioning elements, when they are aligned with one another, bring about a correct orientation of the plane of the spray mist outlets relative to the direction of the duct.

13. The firefighting system as claimed in claim 11, wherein the duct spray mist nozzle has a first spray mist outlet, which is oriented perpendicularly to the opposite side wall, and two second spray mist outlets, which are each oriented at a predetermined angle to the first spray mist outlet, wherein one of the second spray mist outlets is directed counter to the direction of the extracted air flow and the other of the second spray mist outlets is directed in the direction of the extracted air flow.

14. The firefighting system as claimed in claim 13, wherein the K-factors of the first and second spray mist outlets of the duct spray mist nozzle are each identical, and lie in a range from 0.3 to 0.5.

15. The firefighting system as claimed in claim 13, wherein the K-factor of the first spray mist outlet of the duct spray mist nozzle is higher than the K-factors of the second spray mist outlets of the duct spray mist nozzle, and the sum of the K-factors lies in a range from 0.9 to 1.5.

16. The firefighting system (100) as claimed in claim 2, wherein the hood has an inlet cross-sectional area in a range from 3 m² to 5 m² and a maximum spacing of horizontally opposite side walls in a range from 2 m to 4 m.

17. The firefighting system as claimed in claim 1, wherein the duct has a flow area in a range from 1 m² to 2 m² and has a maximum spacing of horizontally opposite side walls in a range from 1 m to 2 m.

18. The firefighting system as claimed in claim 2, wherein the hood spray mist nozzle and the at least one spray mist nozzle further comprises a duct spray mist nozzle installed adjacent thereto have a spacing in a range from 1 m to 3 m in the direction of the extracted air flow.

19. The firefighting system (100) as claimed in claim 1, wherein the at least one spray mist nozzle comprises a plurality of duct spray mist nozzles installed in the duct and have a spacing in a range from 9 m to 11 m from one another in the direction of the extracted air flow.

20. The firefighting system as claimed in claim 1, wherein the at least one spray mist nozzle comprises a plurality of spray mist nozzles fluidically connected to an extinguishing fluid supply, wherein the spray mist nozzles and the extinguishing fluid supply are designed for an operating pressure at the spray mist nozzles in a range from 50 bar to 65 bar.

21. The firefighting system as claimed in claim 9, wherein the duct has an elbow, and wherein the duct spray mist nozzle is installed downstream and/or upstream of the elbow and has a spacing in a range of 6 m or less from the elbow.

22. The firefighting system as claimed in claim 2, wherein the at least one spray mist nozzle is formed partially or entirely from stainless steel.

23. The firefighting system as claimed in claim 9, wherein the duct spray mist nozzles are in the form of open extinguishing nozzles.

24. The firefighting system as claimed in claim 2, wherein one or more fire characteristic sensors are installed at the hood and/or at the duct, and wherein the firefighting system has a triggering device that is connected to the one or more fire characteristic sensors indirectly or directly in a signal-conducting manner and is designed to start a feed of extinguishing agent to the at least one spray mist nozzle as soon as the one or more fire characteristic sensors sense reaching or exceeding of a predetermined fire characteristic threshold or an existence of a fire characteristic.
